(19) United States
(12) Patent Application Publication
(10) Pub. No.: US 2020/0367999 A1
(43) Pub. Date: Nov. 26, 2020

(54) Digitizing and merging sectional impression trays to create a dental arch for dental device manufacturing

(71) Applicant: Jason Griffiths, Dorval (CA)

(72) Inventor: Jason Griffiths, Dorval (CA)

(21) Appl. No.: 16/880,672

(22) Filed: May 21, 2020

Related U.S. Application Data
(60) Provisional application No. 62/851,354, filed on May 22, 2019.

(51) Int. Cl. A61C 9/00; A61C 7/00; G06F 30/10

(52) U.S. Cl. CPC A61C 9/0006; G06F 2113/10; G06F 30/10; A61C 7/002

(57) ABSTRACT

The invention relates to a method and kit for preparing a dental device. The method includes the steps of: (a) providing a dental impression kit to a user; (b) receiving a dental impression from the user from the dental impression kit; (c) digitizing each dental impression to form a three dimensional image; (d) merging the digitized images to form a three dimensional image of the arch; and (e) manufacturing a dental device from the three dimensional image of the arch.

### CROSS-REFERENCE TO RELATED APPLICATIONS

This application claims the benefit of priority of provisional application No. 62/851,354, filed on May 22, 2019, the contents of which are incorporated herein in their entirety.

### BACKGROUND OF THE INVENTION

Currently, dental professionals use sectional impression trays to capture a portion of the dental arch that is required to manufacture a custom product such as an implant, crown, bridge, space maintainer and drill guide. But this is not the procedure for capturing the full dental arch. Instead, one full arch dental impression trays are the standard for capturing an imprint of all the teeth at once. While this is a fast process, it is known that there may be inaccuracies in the imprint and discomfort for the user. From inserting the tray to removing it, the teeth must be centered within the tray to ensure the impression material encapsulates the entire anatomy of each tooth. This can be difficult if the user has a sensitive gag reflex that limits how long the tray can be left in the mouth or whether the tray can be kept on the teeth without undue movement relative to the teeth.

Beyond the advantage of the speed of the process (i.e., using a single impression tray), there are disadvantages associated with the current process for capturing the full dental arch. For example, one disadvantage of the current process is the potential for inaccurate alignment or positioning of each tooth in the impression tray. However, the accuracy of the alignment or positioning is dependent on the process by which the full arch tray is inserted into the mouth, inserted around the teeth, positioned over all of the teeth, and removed from the mouth. This limits the ability for taking precise dental impressions with full arch trays on a reliable and consistent basis.

### SUMMARY OF THE INVENTION

In one aspect, the invention includes a first step of a laboratory providing a dental impression kit to a user; a second step of the laboratory receiving a dental impression from the user from the dental impression kit; a third step of digitizing each dental impression to form a three dimensional image; a fourth step of merging the digitized images to form a three dimensional image of the arch; and a fifth step of manufacturing a dental device from the three dimensional image of the arch.

The kit may include two or more dental impression trays in which each tray is configured to have an overlap of at least one tooth. The kit may include two or more dental impression trays in which each tray is configured to have an overlap of at least two teeth. The kit may include three dental impression trays in which each tray is configured to have an overlap of at least one tooth or at least two teeth.

The fourth step of merging the digitized images may include a step of aligning the images.

In one aspect, the invention relates to a method of preparing a dental device. The method includes the steps of: (a) providing a dental impression kit to a user; (b) receiving a dental impression from the user from the dental impression kit; (c) digitizing each dental impression to form a three dimensional image; (d) merging the digitized images to form a three dimensional image of the arch; and (e) manufacturing a dental device from the three dimensional image of the arch.

Embodiments of the method may include one or more of the following features. For example, the dental impression kit may include two or more dental impression trays in which each tray is configured to have an overlap of at least one tooth. The dental impression kit may include two or more dental impression trays in which each tray is configured to have an overlap of at two teeth. The kit may include at least three dental impression trays in which each tray is configured to have an overlap of at least one tooth. The kit may include at least three dental impression trays in which each tray is configured to have an overlap of at least two teeth.

The step of merging the digitized images may include a step of aligning the images.

In another general aspect, the invention relates to a dental impression kit comprising at least two impression trays in which each tray is configured to have an overlap of at least one tooth with the adjacent tray and the combination of the impression trays forms an entirety of the dental arch.

Embodiments of the dental impression kit may include one or more of the following features. For example, the dental impression kit may include two impression trays in which each tray is configured to have an overlap of two teeth with the adjacent tray and the combination of the impression trays forms an entirety of the dental arch.

The dental impression kit may include three impression trays in which each tray is configured to have an overlap of one tooth with the adjacent tray and the combination of the impression trays forms an entirety of the dental arch. The dental impression kit may include three impression trays in which each tray is configured to have an overlap of two teeth with the adjacent tray and the combination of the impression trays forms an entirety of the dental arch.

### BRIEF DESCRIPTION OF THE DRAWINGS

FIG. 1 is an illustration of the anatomy of a typical dental arch.

FIG. 2 is an illustration of two imprints from two different but overlapping impression trays.

FIG. 3 is an illustration of the digital imprint from three different but overlapping impression trays.

FIG. 4 is an illustration of the top view three separate 3D imprints from FIG. 3 inline and overlaid.

FIG. 5 is an illustration of a dental impression tray.

FIG. 6 is an illustration of a dental arch showing the impression area created by the dental impression tray of FIG. 5.

FIG. 7 is an illustration of a dental impression tray.

FIG. 8 is an illustration of a dental arch showing the impression area created by the dental impression tray of FIG. 7.

FIG. 9 is an illustration of a dental impression tray used in a three impression tray kit.

FIG. 10 is an illustration of a dental arch showing the impression area created by the dental impression tray of FIG. 9.

FIG. 11 is an illustration of a dental impression tray used in a three impression tray kit.

FIG. 12 is an illustration of a dental arch showing the impression area created by the dental impression tray of FIG. 11.

FIG. 13 is an illustration of a dental impression tray used in a three impression tray kit.

FIG. 14 is an illustration of a dental arch showing the impression area created by the dental impression tray of FIG. 13.

FIG. 15 is an illustration of a dental arch showing the impression area created by the dental impression trays of FIGS. 9, 11 and 13.

### DETAILED DESCRIPTION OF THE INVENTION

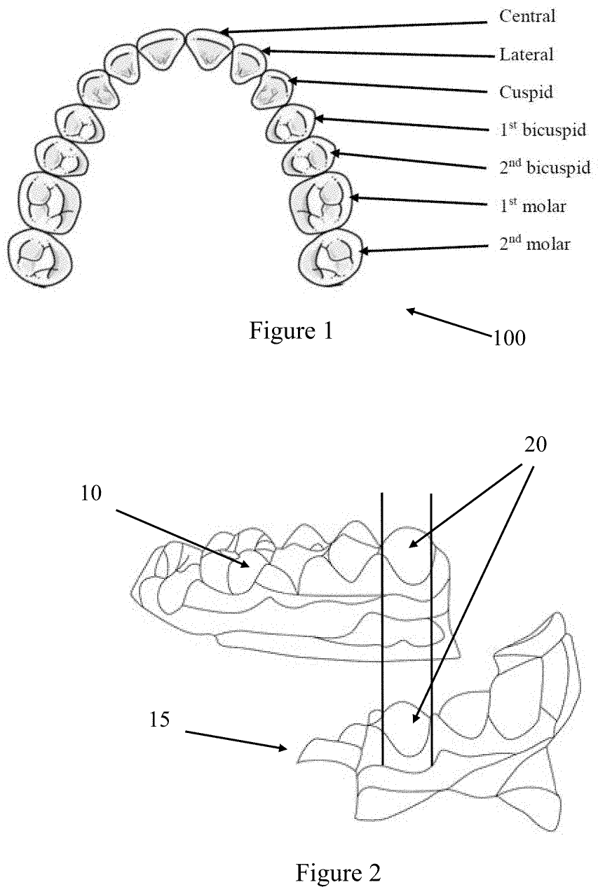

Referring to FIG. 1, the anatomy of a typical dental arch includes from the posterior of one side to the posterior of the other side, a second molar, a first molar, a second bicuspid, a first bicuspid, a cuspid, a lateral, and central to the middle point of the arch.

The invention relates to a process and kit that allows a patient to take their own dental impressions using a set of sectional impression trays, 3D scanning of each tray to form a digital version of the dental impression, and digitally merging the 3D files to form a dental arch.

The trays are specially designed to capture a portion of the dental arch to ensure more accuracy, stability, precision and with less discomfort for patients with sensitive gag reflexes. To accomplish these objectives the kit includes two or more trays in which each pair of trays is designed to create an overlap of part of the arch between two adjacent trays. For example, two adjacent trays may have an overlap of part of one tooth, an overlap of an entire single tooth, an overlap of an entire single tooth and part of a second tooth, an overlap of two entire adjacent teeth, or an overlap of more than two entire adjacent teeth. The amount of overlap is not intentionally limited and the amount of overlap is selected to provide accuracy while also providing patient comfort. Thus an overlap of three teeth, four teeth, five teeth, etc. is included within the scope of the invention.

The trays may be made from any of a number of materials. For example, the trays may be made of metal, polymer (natural or synthetic), rubber, ceramic, composite, a cellulosic material or a combination of these. The material may be selected based on a combination of a number of factors, such as safety, cost, weight, durability, organoleptic, and environmental impact.

With teledentistry becoming more popular, it is critical that when patients take their own dental arch impression, they ensure a proper fitting to obtain the desired precision of the custom fitted dental device. Without the proper fitting of the dental arch impression, there is increased risk that the custom fitted dental device will not accurately fit the arch. To ensure proper fitting of the impression tray, the inventor determined that with a combination of multiple impression trays to encompass the arch, digitizing the impression trays, computer aided alignment of the resulting impressions and then computer aided manufacturing, a properly, custom fitted dental device may be prepared.

In a first embodiment, the inventors have determined that three trays may be used for this process and that are designed to capture the following regions of the arch:

(Upper and Lower) left and right posterior sectional tray: (3 molars and 2 bicuspids)

(Upper and Lower) left and right quadrant sectional tray: (Half of the arch) (1× central, 1× lateral, 1× cuspid, 2× bicuspids and 3× molars)

Upper and Lower Anterior sectional tray: (2 Centrals, 2 Laterals, canine and 1 bicuspid)

In a variation on this first embodiment, the (upper and lower) left and right posterior sectional trays may be used to a take an impression of the 3 molars, 2 bicuspids and a canine tooth. In this variation there is an overlap between each posterior sectional tray and the anterior sectional trays. Specifically, the overlap between the posterior section trays and the anterior sectional trays will be of a canine and a bicuspid. If desired, an additional tooth, or part of an additional tooth, may be included in the overlap.

The trays allow for multiple impressions of the same teeth to be taken. The right quadrant tray will include the same impressions of the molars and bicuspids taken with the smaller right posterior tray. The right quadrant tray will also include the same impressions taken with the anterior tray which includes the central, lateral, cuspid and 1^{st} bicuspid. By capturing more than one impression of a tooth, it allows for easy comparison to confirm accuracy and allows for a greater amount of people with missing teeth to benefit from taking dental impressions.

An impression material is placed in each tray for the patient to place their teeth into. The user begins by taking an impression of the posterior region of their arch and holds the tray in place for the period it takes for material to harden. Following this step, the patient gently removes the tray by applying slight and gentle downward pressure on the corners of the tray until it is fully disengaged from the teeth and removed from the mouth. It should be understood that numerous varieties of impression materials are known to those of skill in the art. Such impression materials are readily available.

After the patient has captured all imprints of the dental arch, the patient sends the trays to a laboratory where each tray is scanned to create a 3D digital version of the impression. The laboratory uses a Computer Aided Design (CAD) program to take the scanned sectional impressions and create the complete digital dental arch from the scanned sectional impressions. To create the complete digital dental arch, a computer technician uses software to align the images or relies on Artificial Intelligence (AI) software to align and overlay two or more exact sections of a tooth/teeth from two different scans to merge and form a larger section of the arch.

In a variation of the above scanning step, the patient may use a cell phone to scan the impression and use a 3D scanning app to create digital files and/or images of the impression. The patient then transfers the digital files/images to the lab or third party entity. The lab could use the digital files/images to either verify that the impression was properly taken or use the image to align and superimpose them to create a 3D image of the full arch. Variations of this embodiment are possible. For example, the kit may be supplied with an apparatus hold the cell phone at different angles to the impression to ensure sufficient views of the impression are taken. Instead or in addition, the kit may include instructions to guide the patient in scanning the impression. For example, the use may be instructed to take a video of the impression from one side to the top and to the other side, or some other orientation. The instructions ensure that the digital file/image has sufficient views of the impression to permit the lab to align and superimpose the images to create a 3D image of the full arch, or to ensure that the impression was properly taken.

In the CAD program the 3D files will be merged by overlapping one or more matching sections of 2 different trays. In FIG. 2, canines from two separate impressions are aligned above each other and will be merged by positioning the digital impressions until the overlay of the two canines matches the exact 3D structure of the same canine on the separate scan. One of skill in the art will be able to readily purchase a CAD program that permits the alignment techniques described herein. Such CAD programs are well-known in the art and are readily available through common commercial channels. The computer used to run the CAD program also is in common usage and readily available to one of skill in the art through common commercial channels.

FIG. 2 is an illustration of a left posterior imprint 10 from a first tray and an anterior imprint 15 from a second tray. A pair of vertical lines are used to emphasize a section 20 of overlapping canines from the left posterior imprint 10 and the anterior imprint 15. This illustration depicts how one of skill in the art might see the alignment process on a computer screen during the process of aligning the imprints.

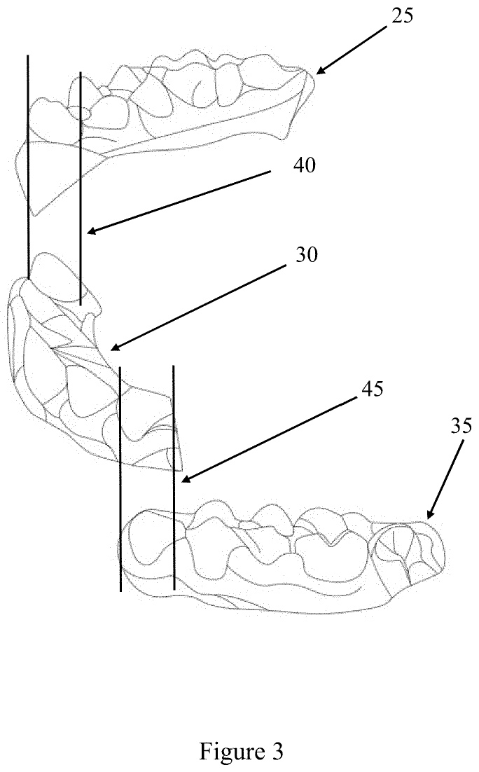

FIG. 3 is an illustration of the digital imprint from the left posterior tray 25, the digital imprint from an anterior tray 30, and the digital imprint from the right posterior tray 35. A first pair of vertical lines are used to emphasize a section 40 of overlapping canines from the left posterior imprint 25 and the anterior imprint 30. A second pair of vertical lines are used to emphasize a section 45 of overlapping canines from the anterior imprint 30 and the right posterior imprint 35. FIG. 3 therefore shows the side view of three digital imprints with all four canines matching over each other to merge and complete the dental arch.

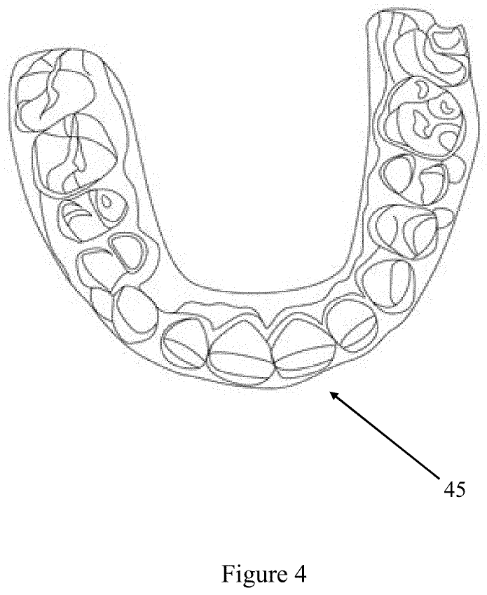

FIG. 4 is an illustration of the top view all three separate 3D imprints from FIG. 3 inline and overlaid with the corresponding canines. The illustration of FIG. 4 is the result of merging the 3D files and using software to align the imprint images into a single dental arch 100.

Once all 3D files are merged and the complete dental arch is formed, the designing and or manufacturing process can begin to create products such as: fixed/active oral appliance, series of clear aligners to correct misaligned teeth, series of bent wires for orthodontic treatment or just simply to have a 3D file of the dental arch.

The complete digital arch can also be produced via additive or subtractive manufacturing processes such as 3D printing and milling. With the physical dental model generated from the merged 3D files, preformed components and materials products can be fitted to the model to complete the dental device.

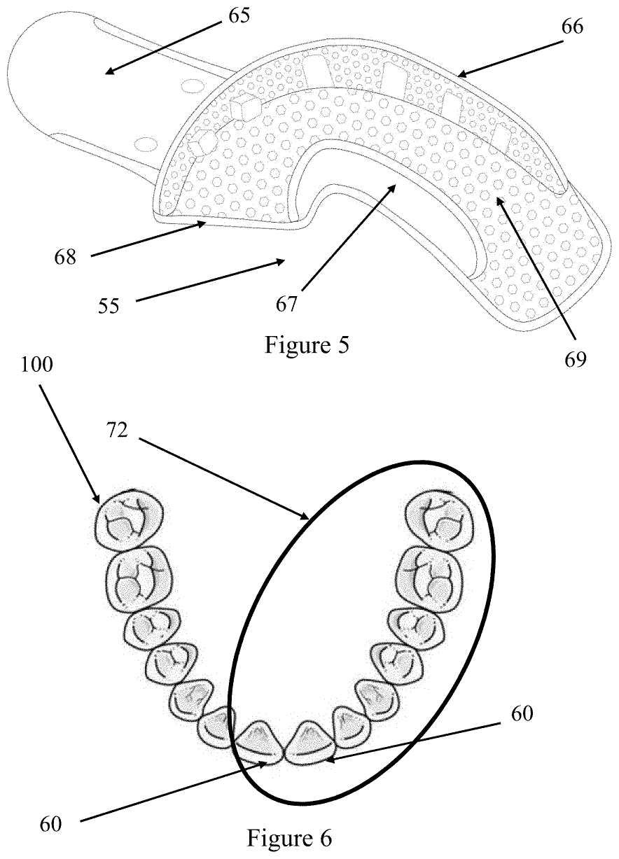

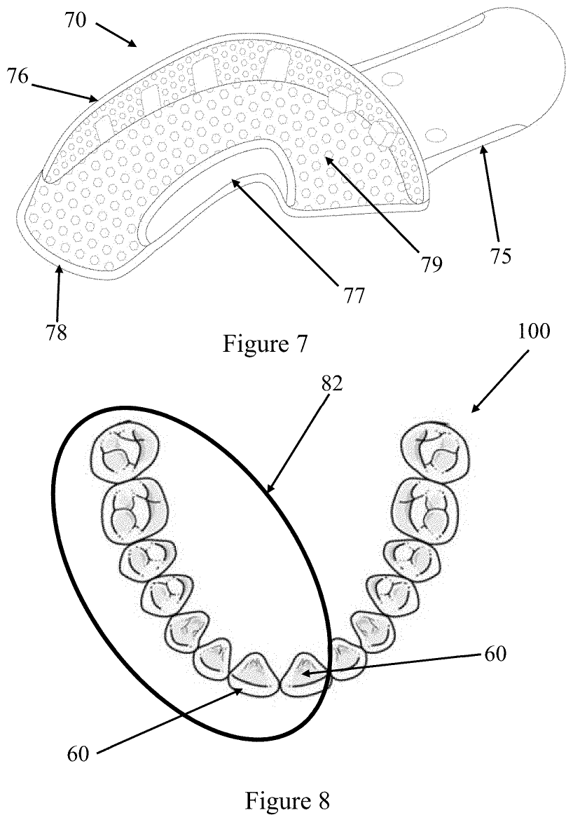

In a second embodiment, the process of taking a dental impression with multiple trays can be based on using only two trays per arch. Referring to FIGS. 5-8, the process can be based on using only the left quadrant tray 50 (FIG. 7) and the right quadrant tray 55 (FIG. 5) to create imprints and then digital impressions of each imprint, and then merging the two images together using the centrals (two front teeth) 60 as reference points. The right quadrant tray 55 includes a handle 65, a pair of side walls 66, 67 and a base wall 68 that together form a channel 69 into which the user places an impression material. The user than fits the channel 69 over the user's teeth to form an imprint of a portion of the arch. Referring also to FIG. 6, which is an illustration of a complete dental arch 100, the right quadrant tray 55 will form an imprint of the teeth within the oval 72. As should be evident, the right quadrant tray 55 is designed to capture all two centrals, lateral, cuspid, 1^{st} and 2^{nd} bicuspids, and 1^{st} and 2^{nd} molars.

The left quadrant tray 70 includes a handle 75, a pair of side walls 76, 77 and a base wall 78 that together form a channel 79 into which the user places an impression material. The user than fits the channel 79 over the user's teeth to form an imprint of a portion of the arch. Referring also to FIG. 8, which is an illustration of a complete dental arch 100, the left quadrant tray 70 will form an imprint of the teeth within an oval 82. In this embodiment, the left quadrant tray 70 is designed to capture all two centrals, lateral, cuspid, 1^{st} and 2^{nd} bicuspids, and 1^{st} and 2^{nd} molars. The left and right quadrant trays have both centrals in common and can be used for aligning the digital images created by digitizing the imprints thus created.

In other embodiments, the smaller sectional trays are also not limited to capturing the teeth in the example used for this explanation. For example, posterior and anterior trays can be small enough to capture only two teeth should the design for smaller trays be required to capture smaller segments of the arch.

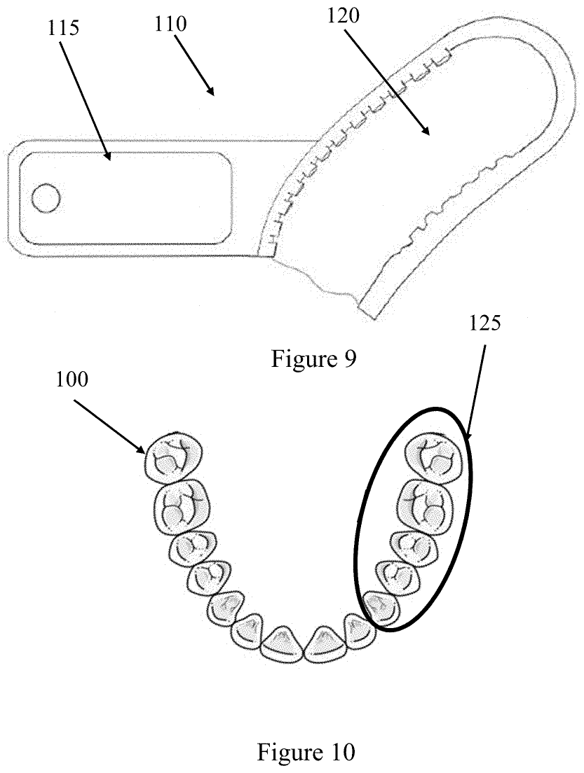

Referring to FIGS. 9-15, in another embodiment of a multi-tray impression system, the system includes three trays for each dental arch but with an overlap of two teeth between each tray. FIG. 9 illustrates the right posterior tray 110, which is designed to take an imprint of one canine, the 1^{st} bicuspid, the 2^{nd} bicuspid, the 1^{st} molar and the 2^{nd} molar. The tray 110 includes a handle 115 and a channel 120 for placing an impression material to take an imprint of a portion of a user's arch. Referring also to FIG. 10, which is an illustration of a complete dental arch 100, the right posterior tray 110 will form an imprint of the teeth within an oval 125, the canine to the 2^{nd} molar.

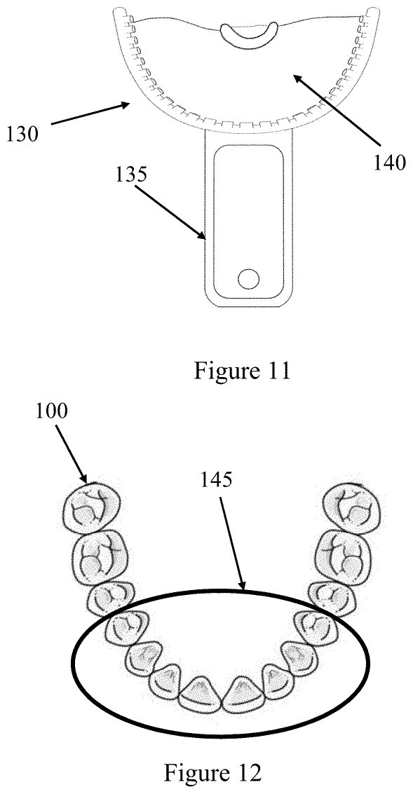

FIG. 11 illustrates the anterior tray 130, which is designed to take an imprint of both centrals, both laterals, both canines and the 1^{st} bicuspids. The tray 130 includes a handle 135 and a channel 140 for placing an impression material to take an imprint of a portion of a user's arch. Referring also to FIG. 12, which is an illustration of a complete dental arch 100, the anterior tray 130 will form an imprint of the teeth within an oval 145.

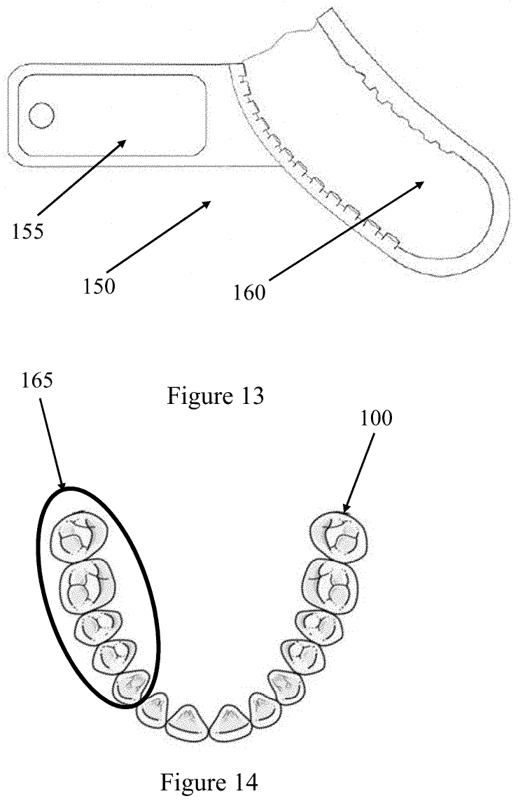

FIG. 13 illustrates the left posterior tray 150, which is designed to take an imprint of one canine, the 1^{st} bicuspid, the 2^{nd} bicuspid, the 1^{st} molar and the 2^{nd} molar. The tray 150 includes a handle 155 and a channel 160 for placing an impression material to take an imprint of a portion of a user's arch. Referring also to FIG. 14, which is an illustration of a complete dental arch 100, the left posterior tray 150 will form an imprint of the teeth within an oval 165, the canine to the 2^{nd} molar.

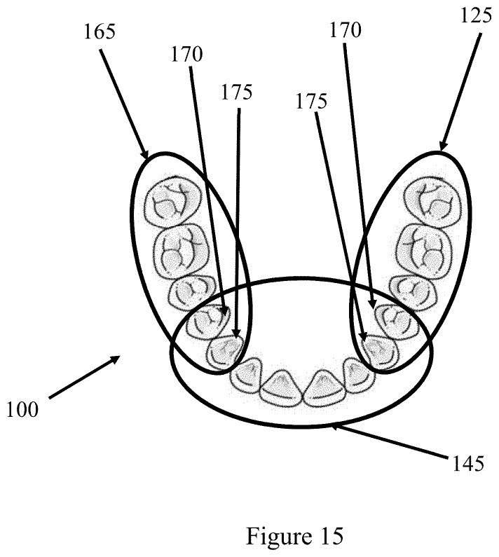

Referring to FIG. 15, which illustrates the overlap of the impressions in FIGS. 9-14, the 1^{st} bicuspids 170 and the cuspids 175 overlap with the left posterior and anterior trays and the right posterior and anterior trays, as indicated by the oval 125, 145, 165 highlighting the impressions and overlaps. Both sided posterior trays and anterior tray overlap the cuspids and first Bicuspids as not all arches have first bicuspids or cuspids. If the trays only overlapped a single tooth and the patient was missing the tooth required for accurate positioning and merging of the 3D scans, the process will not allow all the files to be accurately merged. Having at least two teeth that the anterior and posterior trays can overlap ensures greater data and reference points to allow for accurate positioning and merging 3D scans.

In yet another embodiment, sectional trays can also be used to capture portions of the palate.

The advantages of using sectional trays to capture the full dental arch (compared to using one full tray for entire arch) may include one or more of the following:
More stability and control when placing tray over teeth
More stability and control when removing tray from teeth
More comfort for patients with gaging reflexes
More room to breath
Ability to easily retake impression of arch segment should the first impression not be accurate

Advances in 3D scanning and CAD programs create the opportunity for full arch impressions to be taken in sections using smaller trays with less material per impression. Greater control, stability and comfort throughout this process will produce more accurate impressions and reduce manufacturing lead times when working with patients directly who do not possess the experience of taking impression on a regular basis like dental assistants.

In one embodiment, the system is used by a laboratory or other entity that provides the impression trays to patients who then take impressions of their own dental arch using an impression material that also is provided by the laboratory or other entity. The patient then mails or couriers the impressions to the laboratory. Upon receipt of the impressions, the laboratory creates digital images of each of the impressions using conventional equipment and software as well known to one of skill in the art. With the digital images of each impression thus created, the laboratory then merges the digital images using conventional equipment and software. The merging may be accomplished entirely through artificial intelligence or manually by a technician, or by a combination of the two. With the merged images, the laboratory then can use computer aided manufacturing to create a three dimensional dental device that is customized for the patient's arch characteristics. The customized dental device then is provided to the patient. It should be understood that the entire process can by overseen or managed by a single entity that controls subentities handling discrete steps. For example, a manufacturer of the system may use a first entity to manufacture the kit with trays and impression material and send the kit to a patient or dentist, a second entity to digitize the images from the impression trays, a third entity to use the digitized images to manufacture a dental device and send them directly to the patient or to a dentist who will fit the device to the patient.

We claim:

1. A method of preparing a dental device, the method comprising the steps of:
(a) providing a dental impression kit to a user;
(b) receiving a dental impression from the user from the dental impression kit;
(c) digitizing each dental impression to form a three dimensional image;
(d) merging the digitized images to form a three dimensional image of the arch; and
(e) manufacturing a dental device from the three dimensional image of the arch.

2. The method of claim 1, wherein the dental impression kit includes two or more dental impression trays in which each tray is configured to have an overlap of at least one tooth with at least one other impression tray.

3. The method of claim 1, wherein the dental impression kit includes two or more dental impression trays in which each tray is configured to have an overlap of at least two teeth with at least one other impression tray.

4. The method of claim 1, wherein the kit includes at least three dental impression trays in which each tray is configured to have an overlap of at least one tooth with at least one other impression tray.

5. The method of claim 1, wherein the kit includes at least three dental impression trays in which each tray is configured to have an overlap of at least two teeth with at least one other impression tray.

6. The method of claim 1, wherein the step of merging the digitized images includes a step of aligning the images.

7. A dental impression kit comprising at least two impression trays in which each tray is configured to have an overlap of at least one tooth with the adjacent tray and the combination of the impression trays forms an entirety of the dental arch.

8. The dental impression kit of claim 7, wherein the dental impression kit comprises two impression trays in which each tray is configured to have an overlap of at least two teeth with the adjacent tray and the combination of the impression trays forms an entirety of the dental arch.

9. The dental impression kit of claim 7, wherein the dental impression kit comprises three impression trays in which each tray is configured to have an overlap of at least one tooth with the adjacent tray and the combination of the impression trays forms an entirety of the dental arch.

10. The dental impression kit of claim 7, wherein the dental impression kit comprises three impression trays in which each tray is configured to have an overlap of at least two teeth with the adjacent tray and the combination of the impression trays forms an entirety of the dental arch.
